(19) United States
(12) Patent Application Publication
(10) Pub. No.: US 2004/0261188 A1
(43) Pub. Date: Dec. 30, 2004

(54) Combination firefighter tool

(76) Inventor: Richard Jerome Mathis, Winter Park, FL (US)

Correspondence Address: DAVID MICHAEL VAUGHAN, 4341 AQUA VISTA DRIVE, ORLANDO, FL, 32839, US

(21) Appl. No.: 10/609,154

(22) Filed: Jun. 28, 2003

(51) Int. Cl. B25D 1/04

(52) U.S. Cl. 7/145; 7/158

(57) ABSTRACT

A combination 13 in 1 tool for use in fighting fires, search and rescue, forcible entry, auto extrications, and salvage and overhaul. An axe/hammer head member is attached to an elongated handle pry bar of various sizes. The handle pry bar forms itself on either side of the axe/hammer head acting as a chop stop for both axe/hammer member. The pry bar member provides a water/gas shut off tool as well as a pry tool. The axe underside is a 3 in 1 tool providing a hydrant wrench, windshield and dry wall cutter, the cutters are used when axe is supplanted past the dry wall or windshield and pulled. The hammer underside provides a spanner wrench for hoses and the common stortz coupling on fire trucks. A rappelling ring is strategically placed to hit safety latch on the stortz allowing one handed operation.

### BACKGROUND OF THE INVENTION

1. Field of the Invention

The present invention relates generally to firefighter tools and, more particularly, to a fireman's axe, hammer, pry bar, wrenches, and cutting tools. Specifically, the present invention relates to an improved combination of firefighting tools performing the functions of 13 tools previously required. The weight of the firefighter tool is balanced so as to be carried and attached to a firefighters harness in a multitude of ways, thus giving each individual firefighter the advantage of performing his normal tasks with out restrictions.

2. Description of the Prior Art

Firefighters are always confronted with unpredictable situations wherein a number of different types of tools might be required. Firefighters face the problem of making quick and forcible entries into burning structures for search and rescue or making quick exits through walls or doors. They respond to automobile extractions where the first procedure is to disconnect the hood and battery before extricating a person from an automobile accident, and in some cases the windshield needs to be removed or cut to extricate persons from said accident. Unpredictable circumstances are emergency situations with time constraints in performance that can save lives. Gaining entry into buildings/structures often requires a prying action or axe to dislodge doorways and windows. A hammering action is also required for breaking out windows and doors to gain entry. Fire hydrants need to be turned on for hoses that are stretched out and coupled quickly especially if firefighters have or are going into a burning building. Troublesome electrical conduits are sometimes cut or ripped out, at times water needs to be turned on or off depending, and gas needs to be turned off in buildings for safety reasons. Firefighters are required after a fire response to pull down ceilings and rip out walls of drywall and plaster to inspect or gain access to fire locations and potential fire locations in a structure.

As has been the case of the above, most firefighters find they may need considerably more than just one particular tool and more importantly in an emergency situation, efficiency is a requirement and any delay is often times fatal, this is the choice the firefighter is faced with in making a choice of carrying one or two tools. Since several firefighters are needed to coordinate with each other when leaving a fire truck to bring into a burning structure or automobile accident, an axe, a hammer, pry bar, spanner wrench, a water and gas tool, a hydrant ring, glass cutter, and saws in order to be prepared for any unknown task that may need to be accomplish. Consequently, a number of firefighters have needed to carry a number of different tools each in order to have the proper number and types of tools for each unpredictable incident. Unfortunately, tools that are not being used at a particular time must be set down and are frequently left where they have been used due to it being cumbersome or that they cant be strapped on or put into a pocket. As a result, and as often is the case, tools are left behind and due to circumstances are needed again, they have to be sent for or risk their lives and the lives of those they are trying to save by performing with improper tools and/or time constraints.

Combination firefighter tools have evolved-over the years in order to attempt to alleviate some of the duplication of separate tools discussed. U.S. Pat. Nos. 5,044,033, 6,289,540 B1, 4,727,609, 5,261,164, 6,367,107 B1, 5,315,724, 4,287,623, 3,219,316, 3,599,255, 3,604,028, 4,597,123, and Des. No. D120,609 and No. D233,405 all disclose various fireman combination tools. Unfortunately, such combination tools have generally been limited in their multiple purposes and have generally been cumbersome to carry, to small to be effective or perform certain functions such as prying with leverage, left after they have been used. While the device disclosed in U.S. Pat. No. 4,287,623 has a plurality of different purposes, its complexity of parts, operation and time possible constraints defeats the purpose of having one sturdy tool at a fire site.

Other utility patents disclosing combination tools, generally in the form of hand axes, includes U.S. Pat. Nos. 89,013, 292,168, 637,253, 790,973, 1,596,602 and 4,030,150 as well as Des. Nos. D35,154, D45,761, 48,231, D67,749, D163,911 D299,414. These remaining patents, both design and utility, illustrate a variety of combination tools which also attempt to serve a multiplicity of purposes. However, none of the mentioned references disclose a combination fire tool which serves 13 or more multiple purposes so as to avoid the requirement of separate axes, hammers and pry bars as well as other tools. Therefore, there remains a need for a combination fire tool which is not breakable in human hands, simple in design and function, of medium in size not to small to be functional and not to large as to be cumbersome to carry, thus allowing it to be carried without obstructing the normal firefighter tasks when worn.

### SUMMARY OF THE INVENTION

Appropriately, it is one object of the present invention to provide a search and rescue, forcible entry, auto extrications, and salvage and overhaul combination firefighting tool.

And accordingly, it is another object of the present invention to provide an improved firefighting tool serving a multiplicity of purposes to permit the requirement of a plurality of tools at any given notice.

Yet another object of the present invention is to provide a firefighter tool as designed for a multi-purpose 13 in 1 tool to use, which is versatile and simple, a one solid forged tool and/or the axe/hammer member is welded to elongated handled pry bar making it unbreakable by human hands.

To achieve the foregoing and other objects and in accordance with the purpose of the present invention, as embodied and broadly described herein, a combination firefighter tool is disclosed. The firefighter tool includes an elongated pry bar handle with a axe/hammer member disposed at one end of the handle and a pry bar member disposed at the opposite end of the handle. The axe/hammer member includes a base portion secured to the handle and a convex sharp edge and cutting portions representing the first disposed side of the base. And a flat blunt face with its bottom portion creating a lip that ends in a concave position resting at the second disposed opposite side of the base. The elongated pry bar handle is electrically insulated with rubber tubing and ends in a pry bar, wedge shaped end with a channel slot cut out of its center.

### BRIEF DESCRIPTION OF THE DRAWINGS

The features of the present invention which are believed to be novel are set forth with particularity in the appended claims. The invention, together with further objects and advantages thereof, may best be understood by reference to the following detailed description taken in conjunction with the accompanying drawings, in which:

FIG. 1 is a side perspective view of a axe/hammer member with elongated handled pry bar as the full embodiment of the presented invention;

FIG. 2 is the top of tool perspective view of axe/hammer member of the tool illustrated in FIG. 1;

FIG. 3 is the back of tool perspective view of axe/hammer member hammer side

FIG. 4 is a side perspective view of an alternate embodiment of the pry bar member of the tool of the present invention;

### DETAILED DESCRIPTION OF THE PREFERRED EMBODIMENTS

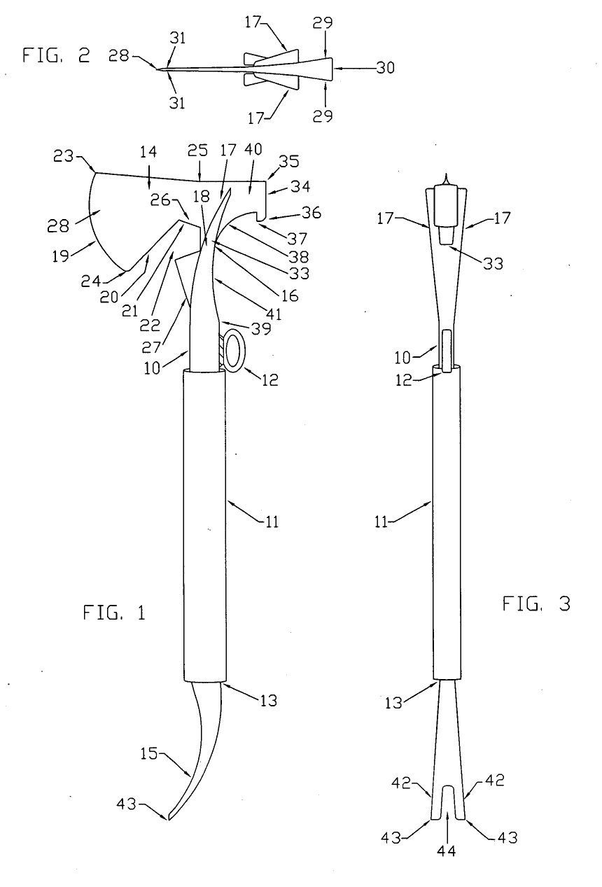

Referring to FIG. 1, a combination emergency search and rescue, forcible entry, auto extrications, and salvage and overhaul firefighting tool comprising of an elongated handle 10 with an electrically insulated rubber grip 11 the length of elongated handle 10 from the bottom of rappelling ring 12 to the pry bar member base portion 13, the elongated handle 10 having first end representing the axe/hammer member 14 and pry bar representing the second end 15, with said firefighting tool being approximately 26″ in length, 1.5″ in handle width with out rubber tubing, 7″ at its widest point, and approximately 8 to 9 lbs. in weight.

Referring to FIG. 1, the axe/hammer member 14 is also represented as the first end and is positioned perpendicular on the base portion of an elongated pry bar handle 16 and comes up both sides of the axe/hammer member 14 creating the chop stop 17 for the axe/hammer head member 14. A pry bar member represents the position at the opposite or second end 15 of said axe/hammer member 14.

The said axe/hammer member 14 axe side base portion 18 nestled on elongated handle 10, constitutes three different cutting positions 19, 20, 21 and a hydrant wrench 22 area on one side of said base portion 18, the first blade 19 is a convex sharp cutting blade 32 that is extended at its tip and top portion 23 runs downwardly towards elongated pry bar 10. The second sharp cutting blade position 20 is straight planed and starts at the bottom rounded curved edge 24, and supports the underside, of the first blade 19, pointing towards the top middle potion 25 of the Axe/hammer member 14. The third cutting position 21 is more a beveled blade then the other sharpened blades and starts where the second sharp cutting blade ends 26 and runs towards the base portion of the nesting area for axe/hammer member 18. A triangle 27 is placed at the beginning of the base portion 18 and nesting area of axe/hammer member 14 creating an open ended wrench appearance and;

Referring to FIG. 2, the axe/hammer member 14 thickness from the cutting edge 28, to the rear side section 29, which terminates in a relatively broad blunt back face, representing the hammer 30. The sides of 29 of the back blunt face 30 are substantially tapered from this point until the tapers reaches the side points 31, respectively, where they taper to a prying or axing point 28.

The top end portion 25 may be utilized as a light ram for drywall or plaster to remove large areas quickly in order to access a room or investigate fires or burning embers behind walls. The first blade convex axe portion 28 is utilized to cut holes in roofs, floors and walls. Additional uses include chopping wood or soft metals to again gain access to rooms or through doors that are bolted tight. The axe blade 19 has significant additional force when cutting as compared to regular fire axes. As previously discussed, the sharp convex edge 28 of FIGS. 1 and 2, is particularly useful for cutting aluminum metals and other light weight metals in automobiles and aircraft for aircraft fires.

A first blade/convex axe 19, 28, rounds at bottom and leads to a strait planed sharpened second cutting blade 20 specifically designed for cutting dry wall and plaster and acts as a guide and leads to the beveled cutting area 21.

A second blade leads 20 and guides cutting material into the beveled area 21 when third cutting edge 21 performs as a windshield cutter 32 or spreader for auto extrication.

A water hydrant wrench 22 is also included in the combination tool and is formed by means of a triangle 27 that is strategically placed to leave an open ended pentagon aperture water hydrant wrench 22 at the bottom of axe/hammer member 14 axe side base portion 18, which is the bottom nesting area of handle. The triangle 27 also acts as a guide for the second 20 and third 21 blade cutters, and the aperture is pentagon in shape for it is current standard of water hydrant valves 22. Favorable results have been found when the aperture is placed slightly forward of the axis of the handle or axe side base portion 18 and in proximity to the top section 25. This position allows the user to apply a maximum torque to a water hydrant valve by utilizing almost all of the height and weight of the tool as lever arm without sacrificing any strength of the axe/hammer member 14 or the elongated pry bar 10.

Representative of FIGS. 1 and 2, a combination firefighting tool said axe/hammer member 14 hammer side base portion 33, is constituted by a first flat plane 34 starting at the tip and top of axe/hammer member 35 a flat plan 34 that is offset or extended out and runs longitudinally in the directions of the elongated pry bar handle 10, the plane ends in a rounded edge 36 stopping and starts another plane 37 running inside creating a concave inward arc 38 towards the elongated pry bar handle 10 longitudinally shorter than the first plane 34 creating a lip 36, at end of lip a concave inward arc 38 is created back to nesting area or hammer side base portion 33. A rappelling ring 12 is placed at the end of the concaved inward arc 39.

In operation, the hammer side portion 40 of the tool may be utilized for a variety of purposes. The hammer end 34 is a useful striking tool for hitting locked wood or metal doors, including dead bolts, for breaking glass in windows and to knock down dry wall and wall framing, to gain entry by a firefighter. It may also be used to drive another tool into door jams for entry as well as hitting a surface that requires significant force to more or remove it from its original position.

In its operation from the bottom portion of hammer 36 concaves downwardly 38 and is a spanner wrench area 41 for opening and closing hose couplings including the fire truck coupling/stortz. The rappelling ring 12 has four major functions, the first function, is to place the rappelling ring 12 to hit the safety mechanism on a fire truck coupling/stortz when spanner wrench 41 is in operation. Second function as its name sake implies, the rappelling ring 12 is used to rappel out of windows in emergency situations by placing the firefighting tool in a 45 degree angle of the window frame. In some instances the firefighter imbeds the axe/hammer member 14 into the wall in the 45 degree angle for added support. The third instance is when firefighters have clipped a d-ring with rope to the rappelling ring 12 and have stood on roof top buildings swinging in arc like fashion the tool to break out window of burning buildings. The fourth function is to place a d-ring on the rappelling ring 12, and when not in use the d-ring is clipped to the o-ring of the firefighters harness to be carried.

Representative of FIGS. 1 and 2, a combination firefighting tool comprising an elongated pry bar 10 having first 16 and second ends 13 on handle, the handle is equipped with a rubber tubing 11 for gripping, swinging, and safety precautions. It starts below the rappelling ring 12 and ends at the pry bar member base portion 13. The elongated pry bar and handle is approximately 26″ in length and used for gripping, prying, and swinging the first 14 and second 15 members respectively with a runner tubing for vibration in pounding, and for electrical safety precautions.

The second end of the handle 13 starts a downward concave area that stops a the end point as in FIG. 1. Shown in FIG. 2 the wedge-shaped pry bar member 15, has sides 42 of the pry bar member 15 that flare outwardly from the diameter of the handle at 13 to a relatively wide lower tip edge 43. As seen in FIG. 2, the thickness of the pry bar member 15 decreases from the diameter of the handle 13 to the edge 43. A rectangular aperture 44 in the center of the pry bar member 15 creates a channel slot 44 that is 1.5″ long.

Representing the pry bar embodiment 15 of the present invention, a channeled slot 044 is formed in-between the pry bar end portion 43. The channeled slot 44 enables the pry bar end portion 43 to function as a below and above ground gas and water valve shut off member. The channeled slot 44 is tapered so as to enable it as a fit over a variety of different sizes of gas and water valve shut off handles. The channeled slot 44 also enables firefighters to pry the automobile hood latch to open hood and to disconnect the battery terminal.

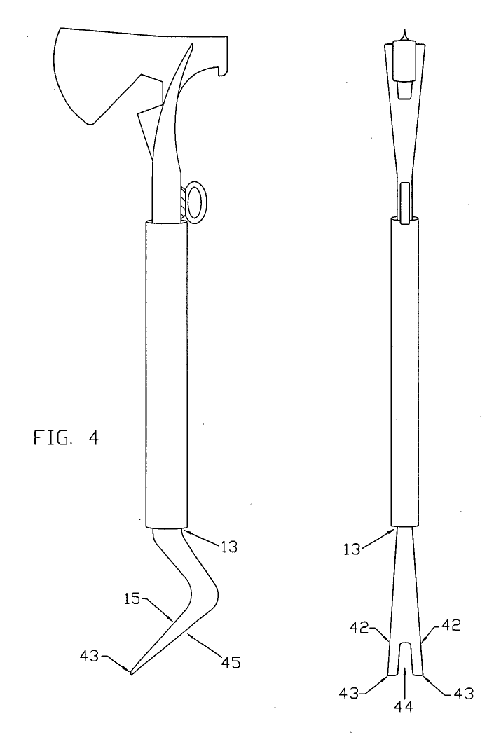

The concave portion of the pry bar member 15 is utilized for getting behind or in-between wood work such as base boards, door trim, shelves and cabinets. This type of prying action is necessary to investigate for smoldering or hidden fires. The concave tapered member 15 is also used to pry away items from or off walls. It is also useful for prying door hinges and the like, and significant leverage is obtained from the length of the handle 10. In addition, a more curved modified pry bar FIG. 4 is used to pull down ceilings of drywall and plaster. To utilize this modified portion 45 of the pry bar member 15, the pry bar member 15 is then shoved up and through ceilings and walls. The modified version FIG. 4 is then utilized to pull down the ceilings. In this manner, the firefighter easily punches the pry bar member 15 through ceilings due to the one arm reach capability in operation of the tool. Moreover, the weight is distributed some what evenly in the entirety of invention and assists in pulling down ceiling materials when using the modified form FIG. 4.

This combination tool is designed basically as a hand tool and is 26″ high and 3″ in handled thickness, and 7″ at its widest point at the axe/hammer member. The entire tool with the exception of the insulated rubber handle can be manufactured in one piece of forged metal, or manufactured with handle pry bar, axe/hammer member, triangle, and rappelling ring welded together with a stick welded with ratings of 6011 and 6013, or wire welded at 0.038, and 0.030. In either, case, the weight and balance lends itself to a tool that can be easily swung and pried with one hand. It should be noted that this combination tool is particularly designed to have the various tools, including the common handle, cooperate with each other. The axe 28 on the front perspective view cooperates with the hammer 40 and prying point on the back side to counter balance the combination tool and thus shares any torque about the longitudinal axis of the handle 10. The aperture or water hydrant wrench 41 is located to distribute the weight of the axe/hammer member 14 and obtain the desired balance. Moreover, the broad back face 34 and particularly the top edge thereof acts as a pivot for the prying point 37.

A pry bar member handle 10 partially counter balances both members 14 and 15 and thus makes the tool easier to carry and use and gives the members 14 and 15 maximum leverage arm torque. The rubber handle 11 readily accommodates one and two hands of which the required forces can be applied to the pry bar member 15. The same observation may be made for the channel slot 44 forming the water, gas, automobile hood release, and battery disconnect.

Significantly, all of these functions can be performed by the firefighter by simply manipulating the single combination tool. It is never necessary for the firefighter to waste valuable time by selecting a new tool for the job. Invaluable time is thus spared during rescue and substantial burden of simply carrying a large number of tools. The significantly lighter and smaller tool load greatly increases the firefighters agility in carrying out his functions.

Prior to the present invention, firefighters have had to carry a variety of tools for; fighting fires, automobile extrications, search and rescue, forcible entry, auto extrications, and salvage and overhaul. Such is the axe, a hammer, a pry bar, hydrant wrench, spanner wrench, water and gas tool, saws for cutting. Each of these tools provided different purposes when a firefighter performed his duties. As can be seen from the above, the present invention combines thirteen of such tool functions into one combination tool, that of an axe, hammer, windshield and dry wall cutter, hydrant and spanner wrench, rappelling ring and fire truck hose (stortz) safety hit, pry bar, water and gas shut off, automobile hood and battery disconnection. Moreover, a thirteen in one tools that is carried by every firefighter by placing a d-ring between the O-ring on the firefighters utility harness and the rappelling ring on the tool, this strategically places the tool at the side of the firefighter when not needed. The thirteen functions all featured into one tool generates a time response for a firefighters reaction time that saves lives in every circumstance they face daily not only for the people they safe but also for the risk they take with there own lives.

Previous to the present invention, firefighters are constantly finding themselves on the scene with the incorrect tools required for fighting fires, automobile extrications, etc. This requires the firefighter to perform the task with the incorrect tool or make unnecessary trips to the fire truck to obtain the right tool. Such delays cause needless damage as well as increased risks to the firefighter, and to the people they rescue. The present invention solves this problem by providing a basic fire fighting tool with all the basic requirements in one multifunctional tool.

Whereas the present inventions description and illustrative embodiments shown in the drawings and described in detail with varying modifications and alternate embodiments. It should be understood, that other and further modifications, apart from those shown in the foregoing descriptions, that they are exemplary only, and that the scope of the invention is limited only to the claims as interpreted in view of the prior art.

What is claim is:

1. A combination emergency search and rescue, forcible entry, auto extrications, and salvage and overhaul firefighting tool comprising:
an elongated pry bar having first and second ends;
said firefighting tool being approximately 26″ in length with said tool being approximately 8 to 9 lbs. in weight;
a axe/hammer member is represented as the first end is positioned perpendicular on the base portion of an elongated pry bar handle that comes up both sides of the axe/hammer member nesting it in its base portion/bottom to top of axe/hammer head member. A pry bar represents the positioned at opposite or second end of said axe/hammer member and;
said axe/hammer member axe side base portion nestled on elongated handle, constitutes three different cutting positions and a hydrant wrench on one side of said base portion, the first blade is a convex sharp cutting blade that is extended at its tip and top portion longitudinally from base portion and runs convex towards elongated pry bar. The second sharp cutting blade position is straight planed and starts at the bottom rounded curved edge, and supports the underside, of the first blade, pointing towards the top middle potion of the Axe/hammer member. The third cutting position is more beveled and not as sharp as the other cutting edges and starts where the second sharp cutting blade ends and runs towards the base portion of the nesting area for axe/hammer member. A triangle is placed at the beginning of the base portion and nesting area of axe/hammer member creating an open wrench appearance and;

2. The tool as claimed in claim 1, wherein said first blade is a sharp cutting edge, and a convex axe made to cut or pry thin metal and wood materials.

3. The tool as claimed in claims 1 and 2, wherein said first blade/convex axe rounds at bottom and leads to a strait planed sharpened second cutting blade specifically designed for cutting dry wall and plaster and acts as a guide and leads to the beveled area.

4. The tool as claimed in claims 1 and 3, wherein said second blade leads and guides into the beveled area when third cutting edge performs as a windshield cutter or spreader.

5. The tools as claimed in claims 3 and 4, wherein a triangle is strategically placed to leave an open ended hydrant wrench to open and close hydrants.

6. The tool as claimed in claim 5, the triangle as the bottom portion of hydrant wrench acts as a guide for second blade drywall and third blade windshield cutters.

7. A combination emergency search and rescue, forcible entry, auto extrications, and salvage and overhaul fire fighting tool comprising:
an elongated pry bar having first and second ends;
Said axe/hammer member hammer side base portion constitutes a first flat plane starting at the tip and top of axe/hammer member a flat plane that is offset or extended out and runs longitudinally in the directions of the elongated pry bar handle, the plane ends in a rounded edge stopping and starts another plane running inside towards the elongated pry bar handle longitudinally shorter than the first plane creating a lip, at end of lip a concave inward arc is created back to nesting area for axe/hammer member. A rappelling ring or chain link is placed at the end concaved area just below the base portion and;

8. The tool as claimed in claim 7, wherein first plane is a striking tool/hammer to break glass, wood frames, dry wall.

9. The tool as claimed in claim 7 and 8, wherein backside and bottom portion of hammer is a spanner wrench for opening and closing hose couplings including the fire truck coupling/stortz.

10. The tool as claimed in claim 7 and 9, whereas a rappelling ring or chain link is strategically placed to hit the safety mechanism on a fire truck coupling/stortz when spanner wrench is in operation.

11. The tool as claimed in claim 7, whereas a rappelling ring is place and balanced for emergency rappelling out of buildings.

12. The tool as claimed in claim 7, whereas rappelling ring or chain link is tied with a rope and swung in arc to break out windows in buildings.

13. A combination emergency search and rescue, forcible entry, auto extrications, and salvage and overhaul fire fighting tool comprising:
an elongated pry bar handle having first and second ends;
an elongated pry bar handle and pry bar being approximately 26″ in length;
said elongated pry bar handle is represented by a pry bar as the second end, and is equipped with a handle rubber tubing/grip that starts below the rappelling ring ending at the representative pry bar member base portion, it's concaved side shaped member from the pry bar base portion tapers in a concave fashion until the end point of pry bar member, a front slotted portion is cut out of the center to the end point of the pry bar member;

14. The tool as claimed in claim 13, wherein an elongated handle equipped for one or both hands provides leverage when prying.

15. The tool as claimed in claim 13, wherein an elongated handle is equipped with a rappelling ring, that is balanced when hung on o-ring harness.

16. The tool as claimed in claim 13, whereas elongated handle is equipped with a rubber tubing for gripping, swinging, pounding, and for safety precautions.

17. The tool as claimed in claim 13, wherein an pry bar is concave and tapers to the end to allow better access to prying doors, windows, and for jabbing and stabbing in tight places.

18. The tool as claimed in claim 13 and 19, wherein pry bar is slotted at its end;

19. The tool as claimed in claim 13 and 18, wherein slotted portion of pry bar acts as a water and gas shut off.

20. The tool as claimed in claim 13, 18, wherein slotted portion of pry bar acts as a automobile hood latch and battery extractor.
